(19) United States
(12) Patent Application Publication
(10) Pub. No.: US 2010/0027128 A1
(43) Pub. Date: Feb. 4, 2010

(54) Lens array

(76) Inventors: Fumio Sato, Otsu-City (JP); Masaaki Kadomi, Otsu-city (JP); Hirokazu Tanaka, Otsu-city (JP)

Correspondence Address: KUBOVCIK & KUBOVCIK, SUITE 1105, 1215 SOUTH CLARK STREET, ARLINGTON, VA, 22202, US

(21) Appl. No.: 12/461,120

(22) Filed: Jul. 31, 2009

(30) Foreign Application Priority Data
Aug. 1, 2008 (JP) 2008-199380
Jul. 2, 2009 (JP) 2009-157385

(51) Int. Cl. G02B 27/12; B29D 11/00

(52) U.S. Cl. 359/620; 264/2.7

(57) ABSTRACT

The lens array 1 includes at least one lens part 3 formed on a surface of a glass substrate 2, and is formed of a press-molded article of optical glass having a refractive index nd of not less than 1.75. The method for producing the lens array 1 includes press molding a preform of optical glass having a refractive index nd of not less than 1.75 using a mold having at least one recess for forming the at least one lens part 3.

### FIELD OF THE INVENTION

This invention relates to lens arrays made of optical glass. More particularly, this invention relates to lens arrays used as optical connectors in optical interconnects.

### BACKGROUND OF THE INVENTION

In recent years, with increase in processing capacity of servers and the like, improvement in packaging techniques for optical circuits and reduction in cost of optical elements and components, the interconnect system is in transition from electrical to optical interconnects. In optical interconnects, a lens array has the function of focusing light emitted from a laser onto an optical fiber, or the function of focusing light emitted from an optical fiber onto a photodetector, such as a photodiode. The lens array has a structure in which a single or plurality of lens parts are formed on a substrate. Specifically, an example of such a lens array is one in which a plurality of lens parts are formed in line with each other and substantially centrally on a rectangular substrate.

Conventionally proposed lens arrays used for the above applications include lens arrays produced by etching pieces of optical glass, and lens arrays produced by injection molding resin (see, for example, Published Japanese Patent Application No. 2001-201609).

### SUMMARY OF THE INVENTION

The production of a lens array by etching of a piece of optical glass involves a plurality of processing steps, which increases the production period and, therefore, leads to very high cost. In addition, lens arrays thus produced have poor dimensional accuracy and vary widely in dimension. Therefore, the lens parts also vary in shape, which presents a problem in that the optical properties, such as robustness to connection loss, are degraded.

Lens arrays produced by injection molding of resin are less likely to have a refractive index as high as glass and, therefore, tend to have a long focal distance. Hence, the lens arrays of this type have difficulty in reducing the size of modules including the lens arrays. In addition, because resin has low resistance to temperature and humidity as compared with glass, there is concern about degradation due to high-temperature and high-humidity environments. Therefore, the lens arrays have a problem of lack of long-term reliability.

The present invention has been made to solve the above problems, and an object thereof is to provide a lens array that has a high refractive index, an excellent environment resistance and a high dimensional accuracy, and is low in cost.

The inventors have found from various studies that the above problems can be solved by a lens array produced from high-refractive index optical glass through a particular process, and propose the lens array as the present invention.

Specifically, a first aspect of the present invention relates to a lens array including at least one lens part formed on a surface of a glass substrate, the lens array being composed of a press-molded article of optical glass having a refractive index nd of not less than 1.75.

According to the first aspect of the present invention, a lens array of desired shape can be produced with high dimensional accuracy as compared with conventional lens arrays produced by etching pieces of optical glass. In particular, the use of the same mold enables the manufacture of high-accuracy lens arrays small in dimensional variation and stable in optical properties. Furthermore, because the grinding process and the polishing process can be eliminated, a lens array having a high surface accuracy (for example, a small number of linear grooves due to polishing or the like) can be produced in a short time, with ease and at low cost.

Since the lens array according to the first aspect of the invention is made of optical glass having a high refractive index nd of not less than 1.75, it can obtain an excellent light gathering capability even if it is designed so that the at least one lens part has a relatively large radius of curvature. Furthermore, with high-refractive index glass, the focal distance of the lens is shorter than those of lenses made of lower-refractive index glass having the same radius of curvature. Therefore, a module including the lens array can be reduced in size. Moreover, if the radius of curvature of the at least one lens part can be increased, this makes it difficult to cause a shortage of glass charged in the recesses of the mold during press molding, whereby a lens array having desired dimensions can be easily obtained. In addition, strains on the at least one lens part due to thermal expansion difference between the mold and the glass can be reduced, which prevents the formation of cracks.

As a result, according to the first aspect of the present invention, a lens array having equivalent properties to conventional lens arrays can be produced relatively easily.

According to a second aspect of the present invention, the radius of curvature of the at least one lens part of the lens array is preferably not less than 0.10 mm.

According to a third aspect of the present invention, the diameter of the at least one lens part of the lens array is preferably 0.05 to 0.5 mm.

Since the diameter of the at least one lens part is not less than 0.05 mm, a light reflection loss is less likely to occur on the lens surface, whereby light emitted from a laser or an optical fiber can efficiently enter the at least one lens part. Furthermore, since the diameter of the lens part is not more than 0.5 mm, it is possible to form a large number of lens parts on a small glass substrate.

According to a fourth aspect of the present invention, the shape of the lens part of the at least one lens array is preferably aspheric.

With an aspheric shape of the at least one lens part, light transmitting the marginal portion of the lens can also be efficiently focused. Therefore, the light coupling efficiency of the optical interconnect can be further increased.

According to a fifth aspect of the present invention, the transmittance of the lens array in the wavelength range of 380 to 1600 nm is preferably not less than 70%.

The lens array according to the above aspect of the present invention has high transmittance over a visible wavelength range and an infrared wavelength range. Therefore, the lens array has a small amount of light loss due to scattering and absorption and an excellent focal power, and is in turn suitable for use as an optical connector in an optical interconnect.

According to a sixth aspect of the present invention, the optical glass of the lens array preferably has a composition in mass percent of 1 to 45% B₂O₃, 5 to 55% La₂O₃, 1 to 50% ZnO, 0 to 35% Gd₂O₃, 0 to 30% SiO₂, 0 to 10% Li₂O, 0 to 40% Ta₂O₅, 0 to 15% ZrO₂, 0 to 25% WO₃, and 0 to 25% Nb₂O₅.

According to a seventh aspect of the present invention, the optical glass of the lens array preferably has a composition in mass percent of 0.1 to 45% B₂O₃, 5 to 55% La₂O₃, 0 to 15% ZnO, 0.1 to 35% TeO₂, 0.1 to 45% WO₃, 0 to 20% SiO₂, and 0 to 15% ZrO₂.

An eighth aspect of the present invention relates to a method for producing a lens array including at least one lens part formed on a surface of a glass substrate, the method including press molding a preform of optical glass having a refractive index nd of not less than 1.75 using a mold having at least one recess for forming the at least one lens part.

### BRIEF DESCRIPTION OF THE DRAWINGS

FIG. 1A is a plane view showing a lens array according to an embodiment of the present invention, and FIG. 1B is a longitudinal cross-sectional view showing the embodiment of the present invention.

FIG. 2 is a longitudinal cross-sectional view showing an concrete example of an aspheric lens part.

### DETAILED DESCRIPTION OF THE INVENTION

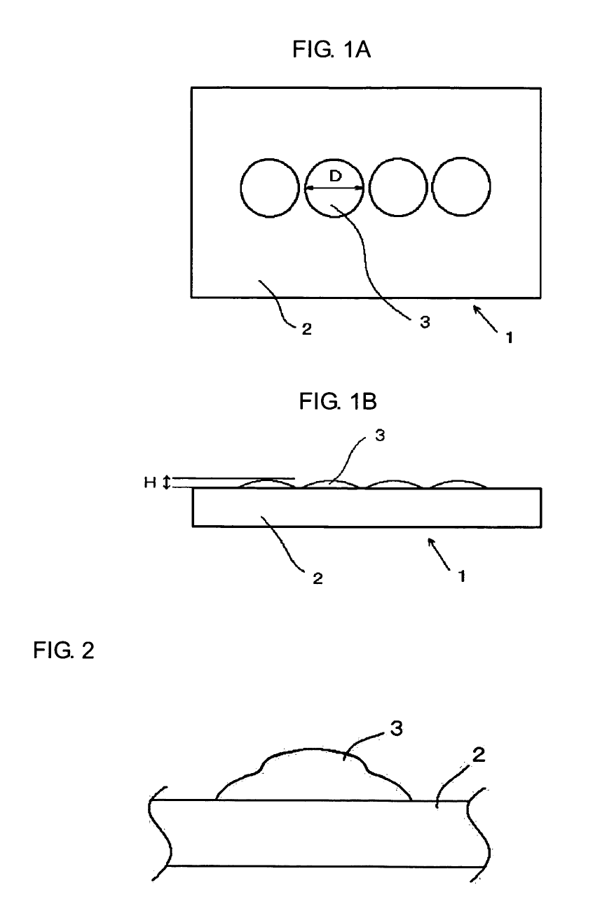

FIG. 1 shows a lens array according to an embodiment of the present invention. As shown in FIG. 1, the lens array 1 has a structure in which a plurality of lens parts 3 are formed, for example, in line with each other, on a glass substrate 2.

Optical glass used for the lens array 1 has a refractive index nd of not less than 1.75, preferably not less than 1.80, more preferably not less than 1.85, and still more preferably not less than 1.90. If the refractive index nd of the optical glass is less than 1.75, a desired focal power is difficult to obtain and the focal distance tends to be long. This makes it difficult to reduce the size of a module including the lens array. The focal power may be increased by designing the lens array so that the lens parts have a small radius of curvature. However, it is difficult to fabricate lens parts having a small radius of curvature with high accuracy.

The type of optical glass used for the lens array 1 is not particularly limited as long as it has the above refractive index nd. Examples of the optical glass include B₂O₃—ZnO—La₂O₃-based glasses and TeO₂—B₂O₃—WO₃—La₂O₃-based glasses. Among them, the use of B₂O₃—ZnO—La₂O₃-based glasses can provide lens arrays have high refractive index, high durability in high-temperature and high-humidity environments and, therefore, high long-term reliability. Note that the term “-based glasses” herein refers to glasses containing ingredients of interest as essential ingredients.

The B₂O₃—ZnO—La₂O₃-based glasses are preferably glasses having a composition in mass percent of 1 to 45% B₂O₃, 5 to 55% La₂O₃, 1 to 50% ZnO, 0 to 35% Gd₂O₃, 0 to 30% SiO₂, 0 o 10% Li₂O, 0 to 40% Ta₂O₅, 0 to 15% ZrO₂, 0 to 25% WO₃, and 0 to 25% Nb₂O₅. The reasons why the content of each ingredient is limited as above is as follows.

B₂O₃ is an ingredient serving as a glass former, and has the effect of increasing the resistance to devitrification. Furthermore, B₂O₃ can decrease the glass softening point. In addition, B₂O₃ also has the function of reducing the basicity of glass and, therefore, is effective in preventing fusion bond of glass and a mold in press molding. The B₂O₃ content is 1 to 45%, preferably 5 to 45%, more preferably 8 to 29%, still more preferably 10 to 24%, and highly preferably 12 to 21%. If the B₂O₃ content is above 45%, the chemical durability of glass tends to decrease, and the weather resistance thereof tends to significantly decrease. On the other hand, if the B₂O₃ content is less than 1%, the resistance to devitrification of glass tends to decrease, whereby it tends to be difficult to stably obtain glass.

La₂O₃ is an ingredient for ensuring a sufficient operation temperature range of glass in press molding, and has the effect of increasing the refractive index of glass. In addition, La₂O₃ also has the effect of reducing the increase in glass softening point and the effect of increasing the weather resistance. However, if a large amount of La₂O₃ is added to the glass in order to obtain a high refractive index, devitrification tends to increase. The La₂O₃ content is 1 to 55%, preferably 5 to 40%, more preferably 5 to 25%, still more preferably 7 to 24.5%, and highly preferably 9 to 24.2%. If the La₂O₃ content is above 55%, devitrification tends to increase and the liquidus temperature tends to rise, which tends to significantly decrease the operation property. On the other hand, if the La₂O₃ content is less than 1%, the refractive index of glass decreases and the weather resistance tends to decrease.

ZnO is an ingredient that can increase the refractive index and chemical durability of glass and decrease the glass softening point. Although glass containing B₂O₃ and La₂O₃ in large amounts is easily devitrified, ZnO has the effect of suppressing the devitrification. The ZnO content is 1 to 50%, preferably 10 to 45%, more preferably 15.5 to 30%, still more preferably 16 to 21%, and highly preferably 16 to 20%. If the ZnO content is above 50%, the glass increases the tendency to cause a phase separation, whereby it becomes difficult to obtain a homogeneous glass. On the other hand, if the ZnO content is less than 1%, the refractive index of glass tends to decrease, the effect of suppressing devitrification cannot be obtained, and the liquids temperature rises to tend to make it impossible to maintain a sufficient operation temperature range.

Gd₂O₃ is an ingredient for increasing the refractive index of glass. By containing Gd₂O₃ in glass, the La₂O₃ content can be reduced and, as a result, the effect of increasing the resistance to devitrification can be provided. Gd₂O₃ is also an ingredient that has the effect of increasing the resistance to devitrification and can extend the operation temperature range. However, if the glass contains a large amount of Gd₂O₃, it increases the tendency to cause a phase separation, whereby it becomes difficult to obtain a homogeneous glass. From these points of view, the Gd₂O₃ content is 0 to 35%, preferably 0 to 25%, more preferably 0.5 to 24%, still more preferably 1 to 15%, highly preferably 2 to 10%, and most highly preferably 3 to 9.5%.

SiO₂ is an ingredient constituting part of a glass former, and has the effect of increasing the resistance to devitrification and extending the operation temperature range. In addition, SiO₂ has the effect of increasing the weather resistance of glass. The SiO₂ content is 0 to 30%, preferably 0 to 20%, more preferably 1 to 15%, and still more preferably 2 to 10%. If the SiO₂ content is above 30%, the refractive index of glass is likely to significantly decrease, and the glass softening point exceeds 650° C. to be likely to make the press molding difficult.

Li₂O is an ingredient for decreasing the glass softening point. The Li₂O content is 0 to 10%, preferably 0.1 to 5%, and more preferably 0.5 to 4%. If the Li₂O content is above 10%, the liquidus temperature of glass significantly rises to narrow the operation temperature range, which tends to have an adverse effect on the mass production. In addition, the weather resistance of glass tends to significantly decrease.

Ta₂O₅ has the effects of increasing the refractive index of glass, increasing the chemical durability thereof and increasing the resistance to devitrification thereof. The Ta₂O₅ content is 0 to 40%, preferably 0 to 20%, more preferably 0.5 to 15%, and still more preferably 1 to 10%. If the Ta₂O₅ content is above 40%, the glass conversely becomes easily devitrified and tends to increase the cost.

ZrO₂ is an ingredient for increasing the refractive index of glass. In addition, ZrO₂ forms glass as an intermediate and, therefore, has the effects of increasing the resistance to devitrification and increasing the chemical durability. However, if the ZrO₂ content is too much, the glass softening point increases, which tends to degrade the press moldability. From these points of view, the ZrO₂ content is 0 to 15%, preferably 0.5 to 10%, and more preferably 1 to 8%.

WO₃ has the effect of increasing the refractive index of glass. In addition, WO₃ forms glass as an intermediate and, therefore, has the effect of increasing the resistance to devitrification. The WO₃ content is 0 to 25%, preferably 0 to 10%, more preferably 0 to 6%, still more preferably 0 to 5%, still more preferably 0.5 to 5%, still more preferably 1 to 4%, still more preferably 1.5 to 4%, still more preferably 1.5 to 3.5%, and highly preferably 2 to 3.5%. If the WO₃ content is above 25%, the glass may be colored to decrease the transmittance and thereby make it difficult to provide desired optical properties, or a fusion bond may occur between the glass and a mold in pressing.

Nb₂O₅ is an ingredient for increasing the refractive index of glass. The Nb₂O₅ content is 0 to 25%, preferably 0 to 15%, more preferably 0.5 to 10%, and still more preferably 1 to 8%. If the Nb₂O₅ content is above 25%, the visible light transmittance of glass tends to decrease, thereby make it difficult to provide desired optical properties.

Various ingredients other than the above ingredients, such as Y₂O₃ or Sb₂O₃, may be added to the glass within the range in which desired properties of glass according to the present invention will not be impaired.

Y₂O₃ is an ingredient that can increase the refractive index of glass without decreasing the Abbe number, and can improve the resistance to devitrification by the replacement with La₂O₃. The Y₂O₃ content is 0 to 15%, preferably 1 to 10%, and more preferably 2 to 8%. If the Y₂O₃ content is above 15%, the glass tends to become easily devitrified and narrow the operation temperature range.

Sb₂O₃ is an ingredient added as a refining agent. The Sb₂O₃ content is 0 to 1%, and preferably 0.1 to 0.5%. If the Sb₂O₃ content is above 1%, the glass tends to be colored to decrease the transmittance.

An example of a more preferable range of compositions in mass percent of the B₂O₃—ZnO—La₂O₃-based glasses is a composition range of 5 to 45% B₂O₃, 5 to 25% La₂O₃, 10 to 45% ZnO, 0 to 25% Gd₂O₃, 0 to 20% SiO₂, 0 to 10% Li₂O, 0 to 20% Ta₂O₅, 0 to 15% ZrO₂, 0 to 5% WO₃, and 0 to 15% Nb₂O₅.

The TeO₂—B₂O₃—WO₃—La₂O₃-based glasses include glasses having a composition in mass percent of 0.1 to 45% B₂O₃, 5 to 55% La₂O₃, 0 to 15% ZnO, 0.1 to 35% TeO₂, 0.1 to 45% WO₃, 0 to 20% SiO₂, and 0 to 15% ZrO₂. The reasons why the content of each ingredient is limited as above is as follows.

B₂O₃ is an ingredient for stability of glass. The B₂O₃ content is 0.1 to 45%, and preferably 4 to 45%. If the B₂O₃ content is less than 0.1%, the above effect is difficult to achieve. On the other hand, if the B₂O₃ content is above 45%, the refractive index of glass is likely to decrease.

La₂O₃ is an ingredient that serves as a glass former and increases the refractive index of glass. The La₂O₃ content is 5 to 55%, preferably 10 to 50%, and more preferably 15 to 40%. If the La₂O₃ content is less than 5%, the glass does not tend to exhibit a sufficient refractive index. On the other hand, if the La₂O₃ content is above 55%, the glass tends to become unstable.

ZnO is an ingredient for thermally stabilizing glass. The ZnO content is 0 to 15%, preferably 0.1 to 10%, and more preferably 1 to 5%. If the ZnO content is above 15%, ZnO has a marked tendency to prevent vitrification.

TeO₂ is an ingredient effective in providing a high-refractive index glass, and also an ingredient decreasing the glass transition point Tg. The TeO₂ content is 0.1 to 35%, preferably 5 to 30%, and more preferably 10 to 25%. If the TeO₂ content is less than 0.1%, the above effects are difficult to achieve. On the other hand, if the TeO₂ content is above 35%, the deterioration of a mold in press molding tends to become more serious.

WO₃ is an ingredient for increasing the refractive index of glass and stability of glass. The WO₃ content is 0.1 to 45%, preferably 1 to 40%, and more preferably 5 to 40%. If the WO₃ content is less than 0.1%, the above effects are difficult to achieve. On the other hand, if the WO₃ content is above 45%, the glass tends to become thermally unstable.

SiO₂ is an ingredient for stability of glass. The SiO₂ content is 0 to 20%, and preferably 0.1 to 10%. If the SiO₂ content is above 20%, the glass tends to become thermally unstable.

ZrO₂ is an ingredient for increasing the refractive index of glass. The ZrO₂ content is 0 to 15%, and preferably 0.1 to 10%. If the ZrO₂ content is above 15%, ZrO₂ has a marked tendency to prevent vitrification.

In addition to the above ingredients, the TeO₂—B₂O₃—WO₃—La₂O₃-based glass may contain other ingredients, such as Nb₂O₅, TiO₂, Al₂O₃, Ta₂O₅, SrO, CaO, BaO, Li₂O, Na₂O, K₂O, GeO₂ or P₂O₅, within the range in which desired properties of glass according to the present invention will not be impaired. Specifically, these ingredients may be contained in a total amount within the range of 0 to 30%, more preferably 1 to 20%.

The glass transition point Tg of an optical glass used for lens array 1 is, in view of ease of press molding, preferably not more than 650° C., more preferably not more than 640° C., and still more preferably not more than 630° C.

In the lens array 1, the radius of curvature (central radius of curvature) of the lens parts is preferably not less than 0.10 mm, more preferably not less than 0.15 mm, still more preferably not less than 0.18 mm, still more preferably not less than 0.20 mm, and still more preferably not less than 0.25 mm. If the radius of curvature of the lens parts is less than 0.10 mm, this makes it easy to cause a shortage of glass charged in recesses of a mold during press molding, whereby a lens array having desired dimensions is difficult to obtain. In addition, because of a thermal expansion difference between the mold and the glass, strains are imposed on the lens parts, whereby the lens parts easily crack. The upper limit of the radius of curvature of the lens parts is not particularly limited. However, if the upper limit is too large, the lens parts cannot fulfill their function as lenses (a light gathering function). Therefore, the upper limit is preferably not more than 1 mm, and more preferably not more than 0.5 mm.

The diameter of each lens part is preferably 0.05 to 0.5 mm, more preferably 0.1 to 0.4 mm, and still more preferably 0.2 to 0.3 mm. If the diameter of the lens part is less than 0.05 mm, only part of light emitted from a laser or an optical fiber enters the lens part, whereby a light loss occurs, or light not entering the lens part tends to have an adverse effect as an eclipse on the surrounding optical elements. On the other hand, if the diameter of the lens part is more than 0.5 mm, it is difficult to form a large number of lens parts on a small glass substrate.

If the lens part is in a spherical shape, light transmitting the marginal portion of the lens may not be focused on the central optic axis. In lens arrays, a plurality of lens parts are arranged in close vicinity to each other on a substrate. Therefore, if transmitted light scatters out of the central optic axis, it may have an adverse effect on the other neighboring optical elements. If the lens parts is in an aspherical shape, light transmitting the marginal portion of the lens can be focused on the central optic axis with high accuracy, which increases the optical coupling efficiency.

An example of such an aspherical shape is a shape whose longitudinal cross section is formed by a quadratic curve. Specifically, an example of the aspheric shape is a lens shape generally expressed by the following series of equations in Formula 1 when the optic axis of the lens part is brought in line with the axis Z of the triaxial (XYZ) orthogonal coordinate system. In the following equations, k is the conic coefficient determining the shape of a quadratic curve, and c is the central curvature (R is the central radius of curvature). FIG. 2 shows a concrete example of such an aspheric lens part.

$${h}^{2} = {x}^{2} + {y}^{2} \\ c = \frac{1}{R} \\ z = \frac{{ch}^{2}}{1 + \sqrt{1 - ( k + 1 ) {c}^{2} {h}^{2}}} \qquad ( 1 )$$

When the conic coefficient k satisfies the range −1<k<0, particularly the range −1<k<−0.7, in a lens array whose lens shape is expressed by the series of equations (1) in Formula 1, the lens shape is a spheroidal aspheric shape. Thus, light transmitting the marginal portion of the lens can be focused on the central optic axis with high accuracy.

The transmittance of the lens array 1 in the wavelength range of 380 to 1600 nm, particularly that of its lens part, is preferably not less than 70%, more preferably not less than 80%, still more preferably not less than 90%, highly preferably not less than 95%, and most highly preferably not less than 99%. If the transmittance in the wavelength range of 380 to 1600 nm is less than 70%, the light loss due to scattering and absorption is large, whereby the lens array tends to have a poor focal power.

When the lens array 1 is attached by adhesion to a photodetector, such as a photodiode, with a UV cure resin, UV light is irradiated through the lens array on the UV cure resin. Therefore, a lens array having a higher transmittance in the ultraviolet region is more preferable because the UV cure resin is irradiated with a larger amount of light and thereby cured more easily. Specifically, the transmittance of the lens array 1 in the wavelength range of 330 to 380 nm is not less than 70%, preferably not less than 80%, more preferably not less than 90%, still more preferably not less than 95%, and highly preferably not less than 99%.

In the present invention, the transmittance of the lens array means the spectral transmittance excluding reflection loss, and refers to the percentage of transmitted light with respect to incident light when the lens array is irradiated with light beams.

In the lens array 1, ridges may be formed on their surfaces. These ridges can be believed to be made so that polishing scratches or the like formed on the mold surface are transformed onto the glass surface in press molding, and can be said to be a feature of the lens array produced by press molding.

Next will be described a method for producing a lens array 1.

First, a glass raw material prepared to have a desired composition is melted into a molten glass. Next, the molten glass is formed into an ingot, thereby obtaining a glass material. Then, the obtained glass material is cut and polished to produce a desired glass preform. Finally, the glass preform is press molded at a temperature higher than the softening point of the glass in a molding press using a mold having a plurality of recesses for forming lens parts, thereby obtaining a lens array of desired shape.

### EXAMPLES

Hereinafter, the present invention will be described in detail with reference to examples, but is not limited to the examples.

### Example 1

A glass raw material was prepared to have a composition of 20% B₂O₃, 25% La₂O₃, 20% ZnO, 10% Gd₂O₃, 5% SiO₂, 1% Li₂O, 7% Ta₂O₅, 5% ZrO₂, 2% WO₃ and 5% Nb₂O₅, and melted at 1300° C. for two hours using a platinum crucible. After the melting, the glass melt was formed into an ingot, and annealed. The obtained ingot was measured for refractive index nd. The measured refractive index nd was 1.806.

The ingot was cut into a desired size, and polished to produce a preform for press molding. The preform was charged into a mold, and press molded in a molding press by heating it to the vicinity of the glass softening point in a vacuum atmosphere and applying a pressure until the lens shape was formed. After the press molding, the molded product was annealed to a room temperature, thereby obtaining a lens array as shown in FIG. 1 in which twelve lens parts were arrayed in line with each other and substantially centrally on a rectangular substrate. There occurred no defects, such as shortage of glass charged in lens parts and cracks during press molding. It was recognized that a plurality of ridges were formed on the surface of the obtained lens array.

The shape and size of the produced lens array was as follows:
The substrate size: 2.5×3.3×0.5 mm
Lens parts (average): 0.201 mm radius of curvature, 0.227 mm diameter, and 0.035 mm height

The dispersion of heights of the twelve lens parts (the difference between the maximum and minimum values of them) was not more than 0.01 mm. Furthermore, produced ten lens arrays were also compared in terms of the heights of their lens parts at the same positions. The dispersion of the heights was not more than 0.01 mm.

The obtained lens arrays were subjected to a light tracing examination (i.e., an examination in which light emitted radially from a surface-emitting laser is focused by a lens array and the amount of light entering an opposed optical fiber is measured). As a result, their light gathering capability was substantially 100%. Furthermore, when the produced lens arrays were allowed to stand for 1000 hours in an environment of 85° C. and 85% RH, no surface alternation, such as tarnish, occurred.

### Example 2

A glass raw material was prepared to have a composition of 5% B₂O₃, 40% La₂O₃, 20% TeO₂ and 35% WO₃, and melted at 1080° C. for two hours using a platinum crucible. After the melting, the glass melt was formed into an ingot, and then annealed. The obtained ingot was measured for refractive index nd. The measured refractive index nd was 1.970.

The ingot was cut into a desired size, and polished to produce a preform for press molding. The preform was charged into a mold, and press molded in a molding press by heating it to the vicinity of the glass softening point in a vacuum atmosphere and applying a pressure until the lens shape was formed. After the press molding, the molded product was annealed to a room temperature, thereby obtaining a lens array as shown in FIG. 1 in which twelve lens parts were arrayed in line with each other and substantially centrally on a rectangular substrate. There occurred no defects, such as shortage of glass charged in lens parts and cracks during press molding. It was recognized that a plurality of ridges were formed on the surface of the obtained lens array.

The shape and size of the produced lens array was as follows:
The substrate size: 2.5×3.3×0.5 mm
Lens parts (average): 0.226 mm radius of curvature, 0.225 mm diameter, and 0.03 mm height

The dispersion of heights of the twelve lens parts (the difference between the maximum and minimum values of them) was not more than 0.01 mm. Furthermore, produced ten lens arrays were also compared in terms of the heights of their lens parts at the same positions. The dispersion of the heights was not more than 0.01 mm.

The obtained lens arrays were subjected to a light tracing examination in the same manner as in Example 1. As a result, their light gathering capability was substantially 100%. Furthermore, when the produced lens arrays were allowed to stand for 1000 hours in an environment of 85° C. and 85% RH, no surface alternation, such as tarnish, occurred.

### Example 3

Using the glass material of Example 1, a lens array was produced by press molding under the same conditions. In the molding, a mold was used whose portions corresponding to lens parts were processed into an aspherical shape so that aspheric lens parts could be formed.

The shape and size of the produced lens array was as follows:
The substrate size: 1.0×5.0×0.37 mm
Lens parts (average): 0.165 mm central radius of curvature, 0.125 mm diameter, and 0.045 mm height
Conic coefficient k: −0.790

The dispersion of heights of the twelve lens parts (the difference between the maximum and minimum values of them) was not more than 0.01 mm. Furthermore, produced ten lens arrays were also compared in terms of the heights of their lens parts at the same positions. The dispersion of the heights was not more than 0.01 mm.

The obtained lens arrays were subjected to a light tracing examination (i.e., an examination in which light emitted radially from a surface-emitting laser is focused by a lens array and the amount of light entering an opposed optical fiber is measured). As a result, their light gathering capability was substantially 100%. Furthermore, when the produced lens arrays were allowed to stand for 1000 hours in an environment of 85° C. and 85% RH, no surface alternation, such as tarnish, occurred.

### INDUSTRIAL APPLICABILITY

As seen from the above description, the lens array according to the present invention has a high dimensional accuracy and light gathering capability while being low in cost, and also has an excellent environment resistance. Therefore, the lens array is suitable for use as an optical connector in an optical interconnect.

What is claimed is:

1. A lens array including at least one lens part formed on a surface of a glass substrate, the lens array being composed of a press-molded article of optical glass having a refractive index nd of not less than 1.75.

2. The lens array of claim 1, wherein the radius of curvature of the at least one lens part is not less than 0.10 mm.

3. The lens array of claim 1, wherein the diameter of the at least one lens part is 0.05 to 0.5 mm.

4. The lens array of claim 1, wherein the shape of the at least one lens part is aspheric.

5. The lens array of claim 1, wherein the transmittance in the wavelength range of 380 to 1600 mm is not less than 70%.

6. The lens array of claim 1, wherein the optical glass has a composition in mass percent of 1 to 45% B₂O₃, 5 to 55% La₂O₃, 1 to 50% ZnO, 0 to 35% Gd₂O₃, 0 to 30% SiO₂, 0 to 10% Li₂O, 0 to 40% Ta₂O₅, 0 to 15% ZrO₂, 0 to 25% WO₃, and 0 to 25% Nb₂O₅.

7. The lens array of claim 1, wherein the optical glass has a composition in mass percent of 0.1 to 45% B₂O₃, 5 to 55% La₂O₃, 0 to 15% ZnO, 0.1 to 35% TeO₂, 0.1 to 45% WO₃, 0 to 20% SiO₂, and 0 to 15% ZrO₂.

8. A method for producing a lens array including at least one lens part formed on a surface of a glass substrate, the method comprising press molding a preform of optical glass having a refractive index nd of not less than 1.75 using a mold having at least one recess for forming the at least one lens part.
